(19) United States
(12) Patent Application Publication
(10) Pub. No.: US 2018/0321510 A1
(43) Pub. Date: Nov. 8, 2018

(54) Optical Article Cutting Blue Light

(71) Applicant: ESSILOR INTERNATIONAL, Charenton-le-Pont (FR)

(72) Inventor: Laura Vetro, Pinellas Park, FL (US)

(21) Appl. No.: 15/773,684

(22) PCT Filed: Nov. 6, 2015
(86) PCT No.: PCT/IB2015/002255

§ 371 Date: May 4, 2018

(51) Int. Cl. G02C 7/02; G02B 1/116; G02C 7/10; G02B 1/16; G02B 5/20; G02B 5/22; G02B 5/28

(52) U.S. Cl. CPC G02C 7/022; G02B 1/116; G02C 7/104; G02B 5/28; G02B 5/208; G02B 5/223; G02B 1/16

(57) ABSTRACT

The present invention relates to an optical article comprising at least one absorbing dye A that selectively and at least partially blocks transmission of light having a wavelength ranging from 400 to 500 nm, wherein dye A has an absorption peak in the range from 400 nm to 460 nm and the absorption spectrum of the optical article is such that the contribution to absorption in the range 400-435 nm is higher than in the range 435-460 nm. This optical article can be used to protect the eyes of a user from photo toxic blue light.

### BACKGROUND OF THE INVENTION

The present invention relates to the optics field, more particularly to an optical article, preferably an ophthalmic lens, having a low level of yellowness, in particular a mostly colorless appearance, comprising an absorbing dye having an optimized absorption spectrum in the blue region of the light spectrum for efficiently blocking at least part of the phototoxic blue light.

Visible light as perceived by humans approximately extends over a spectrum ranging from a 380 nm wavelength to a 780 nm wavelength. The part of this spectrum, ranging from around 380 nm to around 500 nm, does correspond to a high-energy, essentially blue light.

Many studies (see for example Kitchel E., “The effects of blue light on ocular health”, Journal of Visual Impairment and Blindness Vol. 94, No. 6, 2000 or Glazer-Hockstein and al., Retina, Vol. 26, No. 1. pp. 1-4, 2006) suggest that part of the blue light has phototoxic effects on human eye health, and especially on the retina.

Indeed, ocular photobiology studies (Algvere P. V. and al., “Age-Related Maculopathy and the Impact of the Blue Light Hazard”, Acta Ophthalmo. Scand., Vol. 84, pp. 4-15, 2006) and clinical trials (Tomany S. C. and al., “Sunlight and the 10-Year Incidence of Age-Related Maculopathy. The Beaver Dam Eye Study”, Arch Ophthalmol., Vol. 122. pp. 750-757, 2004) demonstrated that an excessively prolonged or intense exposure to blue light may induce severe ophthalmic diseases such as age-related macular degeneration (ARMD) or cataract.

Thus, it is recommended to limit the exposure to blue light potentially harmful, in particular as regards the wavelength band with an increased dangerousness (420-450 nm).

To that end, it may be advisable for a spectacle wearer to wear before each of both eyes an ophthalmic lens that prevents or limits the phototoxic blue light transmission to the retina.

It has already been suggested, for example in the patent application WO 2008/024414, to cut at least partially the troublesome part of the blue light spectrum from 400 nm to 460 nm, by means of lenses comprising a film partially inhibiting the light in the suitable wavelength range, through absorption or through reflection. This can also be done by incorporating a yellow absorbing dye into the optical element.

The application WO 2014/133111 discloses an optical material containing one or more ultraviolet absorbers having a maximum absorption peak in a range from 350 nm to 370 nm, which is configured to restrict exposure of the eyes of a user to blue light with relatively short wavelengths, specifically in the 400 to 420 nm wavelength range.

The international patent application WO 2014/055513 discloses a lens comprising several coatings wherein a coating named primer, comprising a dye, is applied directly in contact with the lens surface and then other coatings are applied over it, such as an UV-block layer and a hard coat.

In view of the foregoing, there is a need for an optical article capable of at least partially blocking transmission of light in the blue region of the light spectrum, while preferably keeping a good transparency and aesthetic based on the user's or wearer's perception.

In addition, it is desirable that the optical article selectively blocks a relatively narrow range of the blue spectrum and exhibits a low level of yellowness. The optical article should be perceived as mostly colorless by an external observer, while providing a high comfort to the wearer in terms of visibility (i.e. not impairing dramatically the wearer's color vision).

It is also desirable to improve contrast and limit dazzling. It is also desirable that the process for manufacturing such an article should be simple, easy to implement and reproducible.

### SUMMARY OF THE INVENTION

To address the needs of the present invention and to remedy the above mentioned drawbacks of the prior art, the applicant provides an optical article comprising at least one absorbing dye A that selectively and at least partially blocks transmission of light having a wavelength ranging from 400 to 500 nm, wherein dye A has an absorption peak in the range from 400 nm to 460 nm and the absorption spectrum of the optical article is such that the contribution to absorption in the range 400-435 nm is higher than in the range 435-460 nm.

The absorption spectrum is obtained from transmittance values T of the optical article for each wavelength in the 380-780 nm wavelength range measured by a spectrophotometer and then the transmittance values of the optical article are converted in absorbance data A using the formula: A=2−log₁₀%T.

Then the absorbance spectrum can be represented. The absorbance values of the optical article take into account all blue blocking due to reflection at the different interfaces (especially at the interface substrate/air) and absorption due to the materials of the optical article (substrate materials, coatings, . . . ). A spectrophotometer can also be programmed to give direct values of absorbance.

Other embodiments of the invention, in addition to the above feature are:

the absorption spectrum of the optical article is such that the ratio R1 of the area under the curve from 435 nm to 460 nm and the area under the curve from 400 nm to 435 nm is lower than 0.7.

the optical article comprises at least one color balancing dye B having an absorption peak at a wavelength higher than or equal to 500 nm,

the absorbing dye A has an absorption peak in the range from 400 nm to 435 nm that exhibits a full width at half maximum lower than or equal to 40 nm, and

As used herein, a dye may refer to both a pigment and a colorant, i.e., can be insoluble or soluble in its vehicle.

Especially, the optical article comprises a substrate having two main faces (i.e. a front face and a rear face), at least one of the face being coated of, starting from the substrate, a first coating, optionally a second coating, an impact-resistant coating, an abrasion-resistant and/or scratch-resistant coating, the absorbing dye A (which partially blocks transmission of light in at least one selected wavelength range of the electromagnetic spectrum) is included at least into the first coating and/or into the second coating.

The present invention thus uses a specific coating dedicated to the filtering function, which avoids modifying the added values provided by the other functional coatings that may be traditionally present at the surface of the optical article.

### DETAILED DESCRIPTION OF THE INVENTION AND PREFERRED EMBODIMENTS

The foregoing and other objects, features and advantages of the present invention will become readily apparent to those skilled in the art from a reading of the detailed description hereafter when considered in conjunction with the accompanying drawings, wherein:

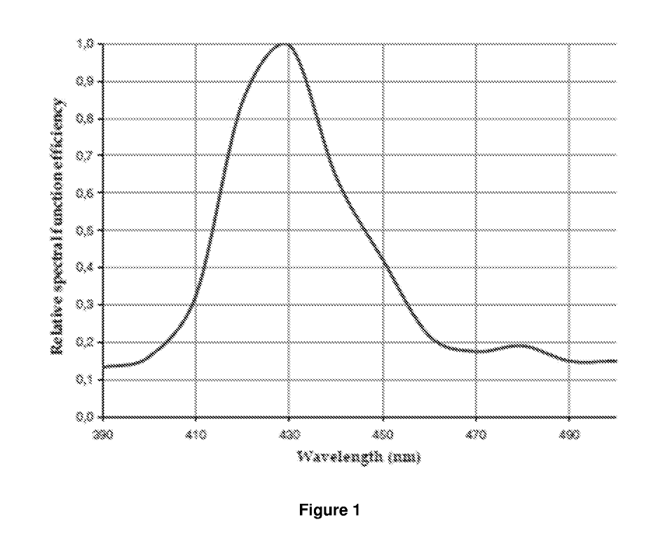

FIG. 1 represents the variation of the light dangerousness function B(λ) between about 400 and 500 nm;

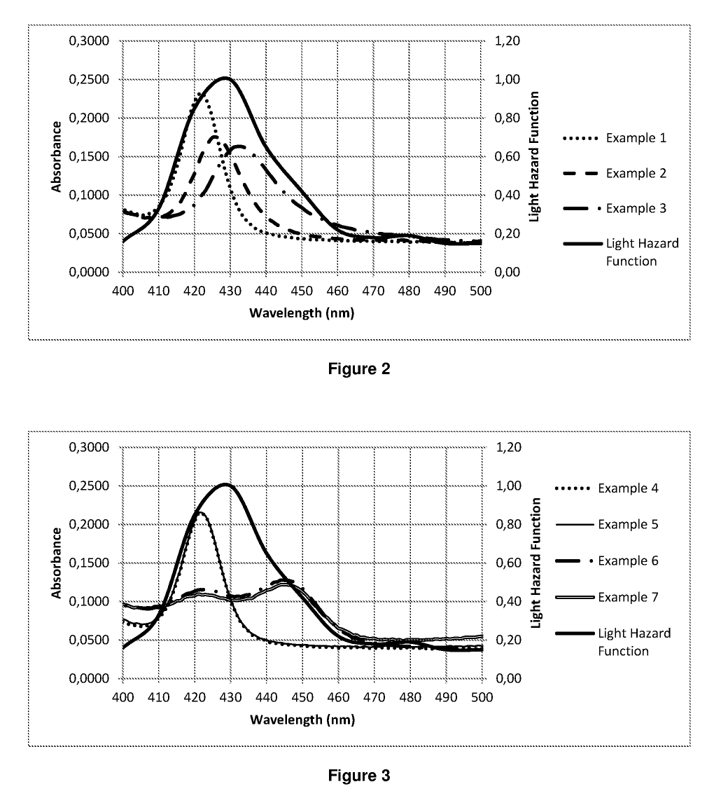

FIG. 2 shows the absorbance curves of three optical article (examples 1 to 3) according to invention between about 400 to 500 nm and the blue light hazard function between about 400 to 500 nm;

FIG. 3 shows the absorbance curves two other optical article (examples 4 and 5) according to invention and two optical article (examples 6 and 7) between about 400 to 500 nm and the blue light hazard function between about 400 to 500 nm;

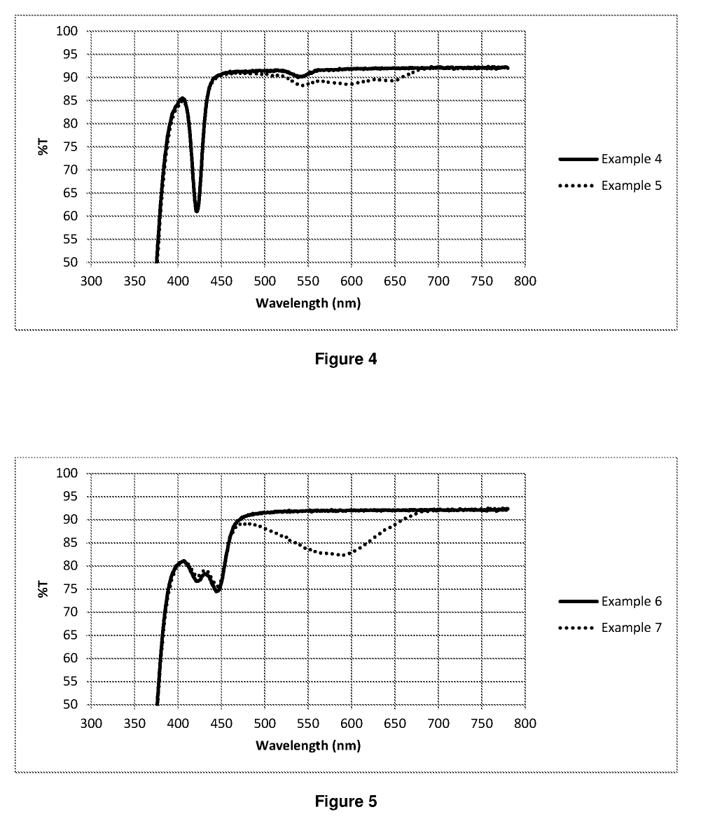

FIG. 4 represents the transmission spectrum (%) of examples 4 and 5 mentioned above according to the invention between about 300 to 800 nm; and

FIG. 5 represent the transmission spectrum (%) of examples 6 and 7 mentioned above according to the invention between about 300 to 800 nm.

As used herein, when an article comprises one or more layer(s) or coating(s) on the surface thereof, “depositing a layer or a coating onto the article” means that a layer or a coating is deposited onto the uncovered (exposed) surface of the article external coating, that is to say the coating that is the most distant from the substrate.

As used herein, a coating that is “on” a substrate/coating or which has been deposited “onto” a substrate/coating is defined as a coating that (i) is positioned above the substrate/coating, (ii) is not necessarily in contact with the substrate/coating, that is to say one or more intermediate coating(s) may be interleaved between the substrate/coating and the relevant coating (however, it does preferably contact said substrate/coating), and (iii) does not necessarily completely cover the substrate/coating. When “a coating 1 is said to be located under a coating 2”, it should be understood that coating 2 is more distant from the substrate than coating 1.

In the context of the present invention, “directly” means that there is a direct contact between the materials and a layer that is fused to a substrate is still considered as being coated on the substrate.

The optical article according to the invention is preferably a transparent optical article, in particular an optical lens or lens blank, more preferably an ophthalmic lens or lens blank.

The term “ophthalmic lens” is used to mean a lens adapted to a spectacle frame to protect the eye and/or correct the sight. Said lens can be chosen from afocal, unifocal, bifocal, trifocal and progressive lenses. Although ophthalmic optics is a preferred field of the invention, it will be understood that this invention can be applied to optical elements of other types where filtering specified wavelengths may be beneficial, such as, for example, lenses for optical instruments, filters particularly for photography or astronomy, optical sighting lenses, ocular visors, optics of lighting systems, screens, glazings, etc.

If the optical article is an optical lens, it may be coated on its front main surface, rear main side, or both sides with the coatings of the invention. As used herein, the rear face of the substrate is intended to mean the face which, when using the article, is the nearest from the wearer's eye. It is generally a concave face. On the contrary, the front face of the substrate is the face which, when using the article, is the most distant from the wearer's eye. It is generally a convex face. The optical article can also be a plano article.

A substrate, in the sense of the present invention, should be understood to mean an uncoated substrate, and generally has two main faces. The substrate may in particular be an optically transparent material having the shape of an optical article, for example an ophthalmic lens destined to be mounted in glasses. In this context, the term “substrate” is understood to mean the base constituent material of the optical lens and more particularly of the ophthalmic lens. This material acts as support for the stack of one or more coatings or layers.

The substrate of the article of the invention may be a mineral or an organic glass, for instance an organic glass made from a thermoplastic or thermosetting plastic, generally chosen from transparent materials of ophthalmic grade used in the ophthalmic industry.

To be mentioned as especially preferred classes of substrate materials are polycarbonates, polyamides, polyimides, polysulfones, copolymers of polyethylene therephthalate and polycarbonate, polyolefins such as polynorbornenes, resins resulting from polymerization or (co)polymerization of alkylene glycol bis allyl carbonates such as polymers and copolymers of diethylene glycol bis(allylcarbonate) (marketed, for instance, under the trade name CR-39® by the PPG Industries company, the corresponding marketed lenses being referred to as ORMA® lenses from ESSILOR), polycarbonates such as those derived from bisphenol-A, (meth)acrylic or thio(meth)acrylic polymers and copolymers such as poly methyl methacrylate (PMMA), urethane and thiourethane polymers and copolymers, epoxy polymers and copolymers, episulfide polymers and copolymers.

The substrate of the optical article is preferably coated on at least one main face with a first coating and optionally a second coating, at least one of which containing at least one absorbing dye A according to the invention.

Preferably, said first coating and/or said second coating contained at least one dye B according to the invention. Preferably, said dye B is contained in the first coating.

Prior to depositing the first coating or the second coating onto the (optionally) coated substrate, the surface of said substrate is usually submitted to a physical or chemical surface activating and cleaning treatment, so as to improve the adhesion of the layer to be deposited. Such pre-treatment is generally conducted under vacuum. It may be a bombardment with energetic and/or reactive species, for example with an ion beam (“Ion Pre-Cleaning” or “IPC”) or with an electron beam, a corona discharge treatment, an ion spallation treatment, an ultraviolet treatment or a plasma-mediated treatment under vacuum, generally using an oxygen or an argon plasma. It may also be a chemical treatment with an aqueous solution of acid or base, hydrogen peroxide or a solvent such as water or an organic solvent.

The first coating is preferably a polyurethane-based coating, i.e., a coating containing at least one polyurethane, which can be obtained by reacting at least one polyisocyanate with at least one polyol. More preferably, the first coating is a polyurethane-acrylate based coating, i.e., a polyurethane coating obtained from acrylate-containing polymerizable compounds. The first coating can also be, without limitation, an acrylic, melamine, epoxy, alkyd, polyester, polyether, or polyamide coating.

The first coating preferably comprises at least 50% by weight of polyurethane compounds, relative to the total weight of the first coating.

The polyols (abbreviation of polyhydric alcohols) which may be used in the present invention are defined as compounds comprising at least two hydroxyl groups, in other words diols, triols, tetrols etc. Polyols pre-polymers may be used.

Non-limiting examples of polyols which may be used in the present invention include (1) polyols of low molecular weight, in other words polyols with a number average molecular weight less than 400, for example aliphatic diols, such as the C2-C10 aliphatic diols, triols, and higher polyols; (2) polyester polyols; (3) polyether polyols; (4) polyols containing amide groups; (5) polyacrylic polyols; (6) epoxypolyols; (7) polyvinyl polyols; (8) urethane polyols; (9) polycarbonate polyols; and (10) mixtures of such polyols.

The polyol is preferably a polymeric polyol, such as a polyether polyol, polyester polyol, polyacrylic polyol or polycarbonate polyol.

When the first coating is a polyurethane-acrylate based coating, this characteristic is preferably obtained by using at least one polyacrylic polyol. Thus, in one embodiment, the first coating composition comprises at least one polyacrylic polyol.

Polyester polyols can be prepared by the polyesterification of an organic polycarboxylic acid or anhydride thereof with organic polyols and/or an epoxide. Generally, the polycarboxylic acids and polyols are aliphatic or aromatic dibasic acids and diols. Polyols of higher functionality, e.g., trimethylolpropane and pentaerythritol, may also be used.

A particularly preferred family of polyester polyols is the family of polylactone polyols (such as polycaprolactone polyols), which can be obtained by simply reacting a lactone with a polyol. Such products are described e.g. in U.S. Pat. No. 3,169,945.

Non-limiting examples of polyether polyols are polyalkylene ether polyols, which include those at paragraph 106 of US 2007/052922. Further polyols useful in the present invention are described in U.S. Pat. No. 7,662,433, in the name of the applicant.

By polyisocyanate, it is meant any compound comprising at least two isocyanate groups, in other words diisocyanates, triisocyanates, etc. Polyisocyanate pre-polymers may be used. The polyisocyanate component which may be used to synthesize the polyurethane includes polyisocyanate compounds with isocyanate groups which are “free”, “blocked” or “partially blocked”, and mixtures of “blocked” and “unblocked” compounds. The term “blocked” means that the polyisocyanates have been changed in a known way to introduce urea (biurea derivative), carbodiimide, urethane (allophanate derivative), isocyanurate groups (cyclic trimer derivative), or by reaction with an oxime.

The polyisocyanates may be selected from aliphatic, aromatic, cycloaliphatic or heterocyclic polyisocyanates and mixtures thereof. Generally, aliphatic polyisocyanates are used because of their superior ultraviolet light stability and non-yellowing tendencies.

The polyisocyanates of the invention are preferably diisocyanates. Among the available diisocyanates may be cited toluene-2,4-diisocyanate, toluene-2,6-diisocyanate, diphenylmethane-4,4′-diisocyanate, diphenylmethane-2,4′-diisocyanate, paraphenylene diisocyanate, biphenyl-diisocyanate, 3,3′-dimethyl-4,4′-diphenylene diisocyanate, tetramethylene-1,4-diisocyanate, hexamethylene-1,6-diisocyanate, 2,2,4-trimethyl hexane-1,6-diisocyanate, lysine methyl ester diisocyanate, bis(isocyanatoethyl) fumarate, isophorone diisocyanate (IPDI), ethylene diisocyanate, dodecane-1,12-diisocyanate, cyclobutane-1,3-diisocyanate, cyclohexane-1,3-diisocyanate, cyclohexane-1,4-diisocyanate, methylcyclohexyl diisocyanate, hexahydrotoluene-2,4-diisocyanate, hexahydrotoluene-2,6-diisocyanate, hexahydrophenylene-1,3-diisocyanate, hexahydrophenylene-1,4-diisocyanate, perhydro diphenylmethane-2,4′-diisocyanate, perhydro phenylmethane-4,4′-diisocyanate (or bis-(4-isocyanatocyclohexyl)-methane, or 4,4′-dicyclohexylmethanediisocyanate), and their mixtures.

The polyisocyanate compound is preferably an aliphatic diisocyanate. It is preferably selected from the group consisting of hexamethylene-1,6-diisocyanate, isophorone diisocyanate, ethylene diisocyanate, dodecane-1,12-diisocyanate, cyclohexane-1,3-diisocyanate, bis-(4-isocyanato-cyclohexyl)-methane and their mixtures, and, even more preferably, from hexamethylene-1,6-diisocyanate, isophorone diisocyanate, ethylene diisocyanate, bis-(4-isocyanatocyclohexyl)-methane and their mixtures.

Other non-limiting examples of polyisocyanates are the isocyanurates from isophorone diisocyanate and 1,6-hexamethylene diisocyanate, both of which are commercially available. Further polyisocyanates suitable for the present invention are described in detail in WO 98/37115.

The first coating composition generally contains polyols, polyisocyanates, and further components such as, but not limited to, additional monomers or polymer resins, solvents such as cyclopentanone, N-methylpyrrolidone (NMP), di(propylene glycol) methyl ether acetate, diethyleneglycol monomethyl ether, ethanol, water or dimethyl sulfoxide, various additives such as free radical scavengers, surfactants, curing/cross-linking agents such as silane coupling agents, rheology modifiers, flow and leveling additives, wetting agents, antifoaming agents, stabilizers, photo-initiators, catalysts such as metal catalysts, IR and/or UV absorbers, dyes providing or not a specific final tint or photochromic properties, and color balancing agents. The three latter compounds will be described later. The composition can be a solution or a dispersion.

For low temperature curing of thermosetting polyurethane compositions, a catalyst such as a tin compound, e.g., dibutyltin dilaurate, is generally present in the polyurethane composition to accelerate the reaction of polyols with isocyanates. Non-tin catalysts such as bismuth carboxylate catalysts can also be used.

The amount of catalyst used can vary. Generally, the amount of catalyst used is in amounts of 0.25 to 0.30 percent by weight, based on weight of resin solids. The conditions adopted for curing the thermosetting polyurethane coating can vary. Generally, polyurethane compositions are cured at a temperature of from 20° C. to 140° C. for from 30 seconds to 4 hours. Lower cure temperatures will require longer cure times. Infrared heating can be used to shorten the cure time until the coating can be handled.

The first coating is deposited on the substrate of the optical article and is preferably in direct contact with said substrate. Its thickness preferably ranges from 500 nm to 100 μm, more preferably from 1 μm to 40 μm, even better from 5 μm to 25 μm.

In one embodiment of the invention, a second coating is deposited on the above described first coating, and is preferably in direct contact with said first coating. The second coating is an adherent film imparting good mechanical properties to the finished product.

In one embodiment, this second coating is used as a protective coating to avoid release of compounds from the first coating when the subsequent coating, generally the abrasion- and/or scratch resistant coating, is applied on the optical article, in particular through liquid-mediated deposition. Said second coating imparts in particular chemical resistance against solvents that may be present in the coating composition to be subsequently deposited. Interleaving the protective second coating between the first coating according to the invention and the abrasion- and/or scratch resistant coating can also help to prevent photo-degradation and oxidation of absorbing dyes or absorbers that may be included in the first coating.

The thickness of the second coating preferably ranges from 50 nm to 50 μm, more preferably from 500 nm to 25 μm, even better from 1 μm to 20 μm.

The second coating can comprise one or more layers/films of the same or different compositions. This coating is preferably an acrylate-based coating and can be prepared using acrylic or methacrylic monomers or a mixture of acrylic and/or methacrylic monomers. As used herein, the terms “acrylic” and “acrylate” are used interchangeably and include derivatives of acrylic acids, as well as substituted acrylic acids such as methacrylic acid, ethacrylic acid, thio(meth)acrylate compounds etc., unless indicated otherwise. The second coating can also be, without limitation, a polyurethane, melamine, epoxy, alkyd, polyester, polyether, or polyamide coating. It can be

The mixture of (meth)acrylic monomers can include mono- or poly-acrylate monomers, such as di-, tri-, tetra-, penta-, and hexa-acrylic monomers. Typically, the higher the functionality, the greater is the crosslink density. Additional co-polymerizable monomers, such as epoxy or isocyanate containing monomers, can also be present in the formulation used to prepare the second coating. Polymerizable compounds combining polymerizable groups of different nature such as alkoxysilyl acrylates can also be employed.

The second coating composition preferably comprises at least 50% by weight of acrylic-functional compounds, relative to the total weight of polymerizable compounds present in said composition.

Examples of acrylic compounds that may be used as main components of the acrylate based coating compositions are:

monofunctional (meth)acrylates: Allyl methacrylate, 2-ethoxyethyl acrylate, 2-ethoxyethyl methacrylate, caprolactone acrylate, isobornyl methacrylate, lauryl methacrylate, polypropylene glycol monomethacrylate, hydroxyethyl methacrylate.

difunctional (meth)acrylates: 1,4-butanediol diacrylate, 1,4-butanediol dimethacrylate, 1,6-hexanediol diacrylate, 1,6-hexanediol dimethacrylate, ethoxylated bisphenol A diacrylate, polyethylene glycol di(meth)acrylates such as polyethylene glycol diacrylate, tetraethylene glycol diacrylate, polyethylene glycol dimethacrylate, polyethylene glycol diacrylate, tetraethylene glycol diacrylate, tripropylene glycol diacrylate, neopentyl glycol diacrylate, tetraethylene glycol dimethacrylate, diethylene glycol diacrylate.

trifunctional (meth)acrylates: Trimethylolpropane trimethacrylate, Trimethylolpropane triacrylate, pentaerythritol triacrylate, ethoxylated trimethylolpropane triacrylate, trimethylolpropane trimethacrylate.

tetra to hexa(meth)acrylates: Dipentaerythritol pentaacrylate, pentaerythritol tetraacrylate, ethoxylated pentaerythritol tetraacrylate, pentaacrylate esters.

As is well known in the art, the amount, number and type of functional acrylates included in the second coating composition will vary depending on the physical properties of the coating that are most desired, since, for example, varying the cross-link density of the film, e.g., by varying the amount of multi-functional acrylates or other cross-linking monomers will modify properties such as hardness, tensile strength, chemical resistance, and adhesion.

The second coating composition preferably comprises 10 to 80% by weight of diacrylate compounds, more preferably 30 to 75%, even more preferably 50 to 70% by weight. The second coating composition preferably comprises 0 to 20% by weight of monoacrylate compounds, more preferably 1 to 10%, even more preferably 2 to 8% by weight. The second coating composition preferably comprises 2 to 30% by weight of triacrylate compounds, more preferably 5 to 25%, even more preferably 5 to 20% by weight. Higher functional acrylate materials, e.g., tetraacrylates, pentaacrylates, hexaacrylates and mixtures thereof can also be used in the formulation, such as in amounts of from 3 to 15% by weight, particularly 5 to 10% by weight. These weight percentages are relative to the total weight of polymerizable compounds present in the composition.

Desirably, the second coating composition contains at least one diacrylate compound and/or at least one monoacrylate compound, preferably at least one hydroxy-functional monoacrylate. This composition also can contain one or more triacrylate compounds. If a triacrylate or higher functional acrylate compound is not used, then adequate cross-linking can be provided by another polymerizable material in the composition.

Commercially available acrylate materials are available from various manufacturers and include those sold under the tradenames, SARTOMER®, EBECRYL® and PHOTOMER®.

The polymerizable second coating composition according to the invention also generally comprises a system for initiating the polymerization. The polymerization initiating system can comprise one or more thermal or photochemical polymerization initiating agents or alternatively, a mixture of thermal and photochemical polymerization initiating agents.

Generally, the initiating agents are used in a proportion of 0.01 to 5% by weight with respect to the total weight of photopolymerizable compounds present in the composition.

Curing the second coating composition can be performed by radiation, such as electron beam curing or ultraviolet light curing. UV curing can require the presence of at least one photoinitiator, e.g., a free radical photoinitiator for acrylate compounds, and a cationic photoinitiator when compounds such as epoxy monomers are present. When the blend of polymerizable compounds is cured, a polymerizate comprising an interpenetrating network of polymer components is produced.

In addition to the above-described components, the second coating composition can include other additives known to those skilled in the art, such as the further components described above in the context of the first coating composition. It can be a solution or a dispersion. Further details on acrylate compositions, including other acrylates, co-monomers, photoinitiators suitable for the present invention can be found in WO 2015/092467 in the name of the applicant or U.S. Pat. No. 7,410,691.

The optical article at least partially inhibits transmission of incident light of light having a wavelength ranging from 400 to 500 nm, i.e., the blue wavelength range, through at least one geometrically defined surface of the substrate of the optical article, preferably an entire main surface. In the present description, unless otherwise specified, light blocking is defined with reference to an angle of incidence ranging from 0° to 15°, preferably 0°.

According to the invention, the angle of incidence is the angle formed by a ray light incident on an ophthalmic lens surface and a normal to the surface at the point of incidence. The ray light is for instance an illuminant light source, such as the standard illuminant D65 as defined in the international colorimetric CIE L*a*b*. Generally the angle of incidence changes from 0° (normal incidence) to 90° (grazing incidence). The usual range of angles of incidence is from 0° to 750°.

The optical article according to the invention preferably blocks or cuts at least 5% of the light in the selected wavelength range, preferably at least 8%, more preferably at least 12%. In the present application, “blocking X %” of incident light in a specified wavelength range does not necessarily mean that some wavelengths within the range are totally blocked, although this is possible. Rather, “blocking X %” of incident light in a specified wavelength range means that an average of X % of said light within the range is not transmitted. As used herein, the light blocked in this way is light arriving on the main face of the optical article onto which the layer comprising the at least one optical filtering means is deposited, generally the front main face.

This attenuation of the electromagnetic spectrum at wavelengths in the above-specified range may be at least 20%; or at least 30%; or at least 40%; or at least 50%; or at least 60%; or at least 70%; or at least 80%; or at least 90%; or at least 95%; or at least 99%; or 100%. In one embodiment, the amount of light having in the selected wavelength range blocked by the optical article ranges from 5 to 50%, more preferably from 8 to 40%, even more preferable from 10 to 30%.

In systems according to the invention, absorbing dye A that filters a selected range of wavelengths is preferably included in at least one of the first coating and the second coating (preferably the first coating). In one embodiment, at least one absorbing dye A is incorporated in the first coating and no dye A is incorporated in the second coating. In another embodiment, at least one absorbing dye A is incorporated in the second coating and no absorbing dye A is incorporated in the first coating. In still another embodiment, at least one absorbing dye A is incorporated in the first coating and at least one optical filtering means, which is different from dye A) is incorporated for example in the second coating, in order, for example, to complete and increase the filtration profile and/or its selectivity.

Said one or more additional optical filtering means can be an absorptive filter that blocks light transmission by absorption, an interferential filter that blocks light transmission for example by reflection, or a combination of both (i.e., a filter that is both absorptive and interferential).

Preferably, said one or more additional optical filtering means blocks light transmission by absorption in a plurality of selected wavelength ranges. Especially, the at least one optical filtering means different from absorbing dye A blocks at least partially transmission of light having a wavelength ranging from 400 to 500 nm. For instance, said optical filtering means is an interferential filter, preferably an antireflection coating (such antireflective lens is described in WO2013171435 and WO2013171436, whose content is incorporated herein by reference).

Since absorbing dye A is not necessarily incorporated into an antireflection coating, the present invention provides protection against blue light, preferably phototoxic blue light, with freedom to select any antireflective coating desired, or provides protection even if no antireflective coating is present at the surface of the optical article.

In a preferred embodiment, absorbing dye A at least partially blocks transmission of light having a wavelength ranging from 400 to 500 nm, especially from 420 to 450 nm or from 415 to 430 nm.

The present optical article can provide a high level of retinal cell protection against retinal cell apoptosis or age-related macular degeneration.

It may be particularly desirable in some cases to selectively filter a relatively small portion of the blue spectrum, i.e., the 420 nm-450 nm region. Indeed, blocking too much of the blue spectrum can interfere with scotopic vision and mechanisms for regulating biorhythms, referred to as “circadian cycles”. Thus, in a preferred embodiment, absorbing dye A blocks less than 5% of light having a wavelength ranging from 465 to 495 nm, preferably from 450 to 550 nm. In this embodiment, absorbing dye A selectively inhibits the phototoxic blue light and transmits the blue light implicated in circadian rhythms. Preferably, the optical article transmits at least 95% of light having a wavelength ranging from 465 to 495 nm. This transmittance is an average of light transmitted within the 465-495 nm range that is not weighted according to the sensitivity of the eye at each wavelength of the range. In another embodiment, dye A does not absorb light in the 465-495 nm range, preferably the 450-550 nm range.

In another embodiment, dye A is an absorptive filter having an absorption peak in the 400-435 nm wavelength range. Preferably, dye A has an has an absorption peak in the range from 400 nm to 460 nm, preferably in the 400-435 nm range, which exhibits a full width at half maximum (FWHM) lower than or equal to 40 nm, preferably lower than or equal to 30 nm. In particular, dye A preferably has an absorption peak in the range from 400 nm to 428 nm, preferably from 415 nm to 428 nm. As used herein, having an absorption peak in a range of wavelengths means that the maximum of the absorption peak falls within this range, said absorption being measured by obtaining an absorption spectrum (absorbance as a function of wavelength) of the optical article having the optical filtering means incorporated therein.

More preferably, said absorption peak is located within the 420-435 nm range. As mentioned above, the dye A has preferably an absorption peak falling within the 400 nm to 428 nm, preferably in the range from 415 nm to 428 nm, i.e., toward the left of the maximum of the B(λ) function shown on FIG. 1.

In particular, dye A also preferably inherently has an absorption peak at a wavelength higher than or equal to 500 nm.

In an advantageous embodiment, dye A has a strong but narrow absorbance peak in the 415-425 nm wavelength range, and preferably has little or no absorption at wavelengths above 435 nm

While preferred absorbing dyes A have an absorption peak at a wavelength lower than 435 nm, it is possible to use an absorbing dye A that has a peak higher than 435 nm and absorbance in the 435-460 nm range if other filtering means are used, so that the resulting optical article is such that the contribution to absorption in the range 400-435 nm is higher than in the range 435-460 nm. These filtering means may be UV absorbers having an absorption in the 400-435 nm range, preferably in the 400-430 nm range.

Preferably an antireflective coating having a maximum reflectance around 400 nm or lower and whose reflectance is decreasing from 400 nm to 450 nm can be used in combination with an absorbing dye A. Such kind of antireflection coating is described in WO2013171435 and WO2013171436 already mentioned hereabove.

The definition of FWHM is FWHM=λhigh−λlow where λhigh and λlow occur on either side of the absorbance peak wavelength, where the absorbance is nearest: (Peak absorbance−Baseline absorbance)/2.

Preferably, the FWHM value of dye A (for the peak in the 400-460 nm range) is lower than 25 nm, in particular lower than 20 nm and preferably higher than 5 nm, typically higher than 10 nm.

In general, dye A has a specific absorption coefficient higher than 200 L.g⁻¹.cm⁻¹ in methylene chloride. In particular, dye A has a specific absorption coefficient higher than 300, preferably 400 and typically higher than 500 L.g⁻¹.cm⁻¹ in methylene chloride.

In the present description, unless otherwise specified, transmittances/transmissions are measured at the center of the optical article for a thickness ranging from 0.5 to 2.5 mm, preferably 0.7 to 2 mm, preferably from 0.8 to 1.5 mm, at an angle of incidence ranging from 0° to 15°, preferably 0°.

Absorbing dye A selectively inhibits transmission of light within the 400-500 nm wavelength range. As used herein, a means “selectively inhibits” a wavelength range if it inhibits at least some transmission within the specified range, while having little or no effect on transmission of wavelengths outside the selected wavelength range, unless specifically configured to do so. In this embodiment, absorbing dye A is configured to minimize the appearance of a plurality of colors.

Indeed, dye A may be configured to inhibit, to a certain degree, transmission of incident light of wavelengths outside the 400-500 nm range, by absorption.

The chemical nature of the absorbing dye that may act as a means for at least partially inhibiting light having the selected wavelength range is not particularly limited, provided that it has an absorption peak in accordance with the invention. Blue light blocking dyes A, typically yellow dyes, are preferably selected to have little or no absorbance in other parts of the visible spectrum to minimize the appearance of other colors.

The blue light blocking dye A may include one or more dyes from the group consisting of: auramine O; coumarin 343; coumarin 314; nitrobenzoxadiazole; lucifer yellow CH; 9,10-bis(phenylethynyl)anthracene; proflavin; 4-(dicyanomethylene)-2-methyl-6-(4-dimethyl aminostyryl)-4H-pyran; 2-[4-(dimethylamino)styryl]-1-methypyridinium iodide, lutein, zeaxanthin, and yellow dyes having a narrow absorption peak available from Exciton Inc. such as ABS-419®, ABS-420®, ABS-425® or ABS-430®.

In embodiments, the blue light blocking dye A comprises one or more porphyrins, porphyrin complexes, other heterocycles related to porphyrins, including corrins, chlorins and corphins, derivatives thereof, or the perylene, coumarin, acridine, indolenin (also known as 3H-indole) and indol-2-ylidene families. Derivatives are substances generally issued by an addition or substitution.

Porphyrins are well-known macrocycle compounds composed of four modified pyrrole subunits interconnected at their carbon atoms via methine bridges. The parent porphyrin is porphine and substituted porphines are called porphyrins. Porphyrins are the conjugate acids of ligands that bind metals to form (coordination) complexes.

Certain porphyrins or porphyrin complexes or derivatives are interesting in that they provide selective absorption filters having a bandwidth in some cases of for example 20 nm in the selected blue range of wavelengths. The selectivity property is in part provided by the symmetry of the molecules. Such selectivity helps to limit the distortion of the visual perception of color, to limit the detrimental effects of light filtering to scotopic vision and to limit the impact on circadian rhythm.

For example, the one or more porphyrins or porphyrin complexes or derivatives are selected from the group consisting of Chlorophyll a; Chlorophyll b; 5,10, 15,20-tetrakis(4-sulfonatophenyl) porphyrin sodium salt complex; 5,10,15,20-tetrakis(N-alkyl-4-pyridyl) porphyrin complex; 5,10,15,20-tetrakis(N-alkyl-3-pyridyl) porphyrin complex, and 5,10,15,20-tetrakis(N-alkyl-2-pyridyl) porphyrin complex, the alkyl being preferably an alkyl chain, linear or branched, comprising 1 to 4 carbon atoms per chain. For example the alkyl may be selected from the group consisting of methyl, ethyl, butyl and propyl.

The complex usually is a metal complex, the metal being selected from the group consisting of Cr(III), Ag(II), In(III), Mn(III), Sn(IV), Fe (III), Co (II), Mg(II) and Zn(II). Cr(III), Ag(II), In(III), Mn(III), Sn(IV), Fe (III), Co (II) and Zn(II) demonstrate absorption in water in the range of 425 nm to 448 nm with sharp absorption peaks. Moreover, the complexes they provide are stable and not acid sensitive. Cr(III), Ag(II), In(III), Sn(IV), Fe (III), in particular, do not exhibit fluorescence at room temperature which is a useful property in optical lenses such as ophthalmic lenses.

In some embodiments the one or more porphyrins or porphyrin complexes or derivatives are selected from the group consisting of magnesium meso-tetra(4-sulfonatophenyl) porphine tetrasodium salt, magnesium octaethylporphyrin, magnesium tetramesitylporphyrin, octaethylporphyrin, tetrakis (2,6-dichlorophenyl) porphyrin, tetrakis (o-aminophenyl) porphyrin, tetramesitylporphyrin, tetraphenylporphyrin, zinc octaethylporphyrin, zinc tetramesitylporphyrin, zinc tetraphenylporphyrin, and diprotonated-tetraphenylporphyrin.

In general, the absorption spectrum of the optical article is such that the ratio R1 of the area under the curve from 435 to 460 nm and the area under the curve from 400 to 435 nm is lower than 0.7, in particular lower than 0.6 and typically lower than 0.5.

This ratio R1 may be easily determined by the measurement of the area under the curve.

Another way to calculate the ratio R1 is to calculate the value AV1: average value of absorbance over the range 435-460 nm and the value AV2 average value of absorbance value over the range 400 to 435 nm and R1=AV1/AV2.

The calculation by area is the preferred method of calculation of R1.

The contribution to absorption in the range 400-435 nm higher than in the range 435-460 nm is considered fulfilled if the ratio R1 calculated by either the area method or the average method is lower than 1.

As mentioned above, in the present description, the optical article can comprise one or more additional optical filtering means, different from dye A, which at least partially blocks transmission of light having a wavelength ranging from 400 to 500 nm, on either main face of the substrate. It can be an absorptive filter blocking light transmission by absorption, an interferential filter that blocks light transmission for example by reflection (i.e., an antireflection coating), or a combination of both (i.e., a filter that is both absorptive and interferential). The optical article may also comprise at least one absorptive filter and at least one interferential filter that both at least partially block incident light having the selected wavelength range. Using an interferential filter in addition to an absorptive filter may improve the aesthetic of the optical article.

In another embodiment, the optical article comprises at least one interferential filter that at least partially blocks incident light having the selected wavelength range on at least one geometrically defined surface of the substrate of the optical article, preferably an entire main surface. The interferential filter, preferably a filter that inhibits light transmission by reflection, is generally a multi-layer dielectric stack, typically fabricated by depositing discrete layers of alternating high and low refractive index materials. Design parameters such as individual layer thickness, individual layer refractive index, and number of layer repetitions determine the performance parameters for multi-layer dielectric stacks. Such interferential filter inhibiting light in a selected wavelength range is disclosed, for example, in the application WO 2013/171434, in the name of the applicant.

In one embodiment, the optical article comprises an UV absorber as an additional optical filtering means at least partially blocking light in the 400-500 nm wavelength range.

Such compounds are frequently incorporated in optical articles in order to reduce or prevent UV light from reaching the retina (in particular in ophthalmic lens materials), but also to protect the substrate material itself, thus preventing it from weathering and becoming brittle and/or yellow.

The UV spectrum has many bands, especially UVA, UVB and UVC bands. Amongst those UV bands reaching the earth surface, UVA band, ranging from 315 nm to 380 nm, and UVB band, ranging from 280 nm to 315 nm, are particularly harmful to the retina.

The UV absorber that may be used in the present invention preferably has the ability to at least partially block light having a wavelength shorter than 400 nm, preferably UV wavelengths below 385 or 390 nm, but also has an absorption spectrum extending to a selected wavelength range within the 400-1400 nm region of the electromagnetic spectrum, such as in the visible blue light range (400-500 nm).

In an embodiment, UV absorbing is configured such that the optical transmittance of the optical article is satisfying at least one of the characteristics (1) to (3) below and preferably these three characteristics:

(1) the optical transmittance at the 435 nm wavelength is 10% or less;

(2) the optical transmittance at the 450 nm wavelength is 70% or less;

(3) the optical transmittance at the 480 nm wavelength is 80% or more.

Suitable UV absorbers include without limitation substituted benzophenones such as 2-hydroxybenzophenone, substituted 2-hydroxybenzophenones disclosed in U.S. Pat. No. 4,304,895, 2-hydroxy-4-octyloxybenzophenone (Seesorb 102®) 2,7-bis(5-methylbenzoxazol-2-yl)-9,9-dipropyl-3-hydroxyfluorene, 1,4-bis(9,9-dipropyl -9H-fluoreno[3,2-d]oxazol-2-yl)-2-hydroxyphenyl, 2-hydroxyphenyl-s-triazines and benzotriazoles compounds.

The UV absorber is preferably a benzotriazole compound. Suitable UV absorbers from this family include without limitation 2-(2-hydroxyphenyl)-benzotriazoles such as 2-(2-hydroxy-3-t-butyl-5-methylphenyl) chlorobenzotriazole, 2-(2′-hydroxy-5′-t-octylphenyl) benzotriazole, 2-(3′-methallyl-2′-hydroxy-5′-methyl phenyl) benzotriazole or other allyl hydroxymethylphenyl benzotriazoles, 2-(2-hydroxy-5-methylphenyl)-2H-benzotriazole (Seesorb®701), 2-(3,5-di-t-amyl-2-hydroxyphenyl) benzotriazole, and the 2-hydroxy-5-acryloxyphenyl-2H-benzotriazoles disclosed in U.S. Pat. No. 4,528,311. Preferred absorbers are of the benzotriazole family. Commercially available products include Tinuvin® and Chimassorb® compounds from BASF such as Tinuvin® 326, Seeseorb® 701 and 703 from Shipro Kasei Kaisha, Viosorb 550® from Kyodo Chemicals, and Kemisorb 73® from Chemipro.

The UV absorber is preferably used in an amount representing from 0.3 to 2% of the weight of the substrate.

According to a preferred embodiment, dye A absorbs radiation such that at least 5% of the light in the 400-500 nm wavelength range is blocked/inhibited, preferably at least 8 or 12%, and generally from 8 to 50%, more preferably from 10 to 40%, even more preferable from 12 to 30% of said light. These levels of light inhibition by absorption can be controlled by adjusting the concentration of dye and/or UV absorber and are expressed relative to the amount of light that would be transmitted at the same wavelength range in the absence of the optical filtering means.

Generally, blocking visible wavelengths such as undesirable blue light affects color balance, color vision if one looks through the optical device, and the color in which the optical device is perceived. Indeed, light-blocking optical devices incorporating at least one of the above described absorptive optical filtering means that at least partially inhibits visible light tend to produce a color tint in the optical article as a “side effect”, the latter appearing yellow, brown or amber in the case of blue light blocking. This is esthetically unacceptable for many optical applications, and may interfere with the normal color perception of the user if the device is an ophthalmic lens.

In order to compensate for an effect such as the yellowing effect of the blue light blocking dye A, the optical article comprises at least one color balancing dye B having an absorption peak at a wavelength higher than or equal to 500 nm.

In one embodiment, the color-balancing component employed to at least partially offset the yellowing effect is a dye, or a mixture of dyes used in suitable proportions, such as a combination of red and green tinting dyes.

Examples of suitable fixed-tint colorants usable as balancing dye B can include, any of the art recognized inorganic and organic pigments and/or dyes. Organic dyes can be selected from azo dyes, polymethyne dyes, arylmethyne dyes, polyene dyes, anthracinedione dyes, pyrazolone dyes, anthraquinone dyes, auinophtalone dyes and carbonyl dyes. Specific examples of such organic dyes include Blue 6G, Violet PF and Magenta RB available from Keystone Aniline, Morplas Blue from Morton International, Inc., D&C Violet #2 available from Sensient Corp., Macrolex Violet 3R from Lanxess, and Rubine Red from Clariant Corporation. Also suitable are laser dyes, for example those selected from pyrromethene, fluoroscein, rhodamine, malachit green, oxazine, pyridine, carbazine, carbocyanine iodide, and others. Specific examples include ABS 574, ABS 668 or ABS 674 from Exiton, Inc.; or SDA2443, SDA3572 or ADA4863 available from H.W. Sands Corp. Mixtures of any of the aforementioned dyes can be used.

In another embodiment, an optical brightener, also called fluorescent whitening agent (FWA), optical brightening agent (OBA) or fluorescent brightening agent (FBA) might be used. As well known, optical brighteners are substances that absorb light in the UV and violet region (usually at 340-370 nm) and emit light by fluorescence mainly in the blue region of the visible spectrum (400-500 nm, preferably in the 420-450 nm range). Preferred optical brighteners have high fluorescence efficiency, i.e., re-emit as visible light a major proportion of the energy they have absorbed.

The chemical nature of the optical brightener is not particularly limited, provided that it is capable of emitting light by fluorescence, ideally a maximum fluorescence, at a wavelength ranging from 400 to 500 nm, preferably 420 to 450 nm, in order to mask the yellow color imparted by the optical filtering means.

Preferably, the optical brightener absorbs less than 30% of the light having a wavelength ranging from 420 to 450 nm or 400 to 500 nm, more preferably less than 20%, even more preferably less than 10%, ideally less than 5%. Said optical brightener preferably has no maximum absorption peak, even better no absorption peak, within the 420-450 nm or 400-500 nm ranges.

The optical brightener may be chosen, without limitation to these families, from stilbenes, carbostyrils, coumarins, 1,3-diphenyl-2-pyrazolines, naphthalimides, combined heteroaromatics (such as pyrenyl-triazines or other combinations of heterocyclic compounds such as thiazoles, pyrazoles, oxadiazoles, fused polyaromatic systems or triazines, directly connected to each other or through a conjugated ring system) benzoxazoles, in particular benzoxazoles substituted at the 2-position with a conjugated ring system, preferably comprising ethylene, phenylethylene, stilbene, benzoxazole and/or thiophene groups. Preferred families of optical brighteners are bis-benzoxazoles, phenylcoumarins, methylcoumarins and bis-(styryl)biphenyls, which are described in more details in A. G. Oertli, Plastics Additives Handbook, 6th Edition, H. Zweifel, D. Maier, M. Schiller Editors, 2009.

Other useful optical brighteners that may be used in the present invention are described in Fluorescent Whitening agents, Anders G. EQS, Environmental quality and safety (Suppl. Vol IV) Georg Thieme Stuttgart 1975. Specific examples of commercially available optical brighteners are disclosed in WO 2015/097186, in the name of the applicant.

Preferably, the color balancing dye B has an absorption peak at a wavelength higher than or equal to 520 nm. For instance, anthraquinone is suitable as color balancing dye B according to the invention.

In general, the optical article has an absorption spectrum such that the ratio R2 of the area under the curve from 460 to 700 nm and the area under the curve from 400 to 460 nm is lower than or equal to 3.

As it is shown in the examples below, the best balance of high blue light protection, low yellowness and high transmission occurs when the R2 ratio is lower than or equal to 3, preferably lower than or equal to 2.5, even better lower than or equal to 2.25.

The ratio R3 (area under the curve from 460 to 700 nm/area under the curve from 400 to 460 nm) is preferably lower than or equal to 3, preferably lower than 2.5, even better lower than 2.25.

In systems according to the invention, a dye A is preferably included in at least one of the first coating and the second coating (preferably the first coating), while a color-balancing means can be incorporated in the substrate of the optical article, in at least one coating at the surface of the substrate or in a layer interleaved between two substrate films.

The color-balancing means can be incorporated in a color-balancing coating or film applied on the surface of the optical article, such as a primer coating, hard coat or antireflection coating. It is preferably included in at least one of the first coating and the second coating according to the invention, more preferably in the first coating.

The color-balancing dye B and dye A can be incorporated in the same coating or separately at different locations, for example in (at least) two different coatings or the first one in the substrate and the other in the first coating or the second coating according to the invention, or a combination of these embodiments can be implemented, while still obtaining the advantages and benefits of the invention in terms of health and cosmetic appearance. For example, dye A may be located in the first coating, and dye B included in a primer coating. In case dyes A and B are included in (at least) two different coatings, these coatings are not necessarily deposited on the same face of the optical article. They can be deposited on either face of the optical article or on both faces of the optical article.

In a preferred embodiment, dyes A and B are both included in the first coating according to the invention.

In one embodiment, the functionality to block blue light wavelengths and the functionality to perform color balancing are combined in a single component that blocks blue light wavelengths and reflects some green and red wavelengths.

Several optical filtering means and/or color-balancing means can be incorporated in the substrate and/or the same or different layers deposited at the surface of the substrate. In some embodiments, the optical filtering means is split between two filters, disposed on the same or different surfaces of the optical substrate.

The optical filtering means is preferably not incorporated in the substrate of the optical article.

Methods for incorporating a color-balancing means in the mass of the substrate of the optical article are well known and include, for example (see e.g. WO 2014/133111):
I. impregnation or imbibition methods consisting in dipping the substrate in an organic solvent and/or water based hot bath, preferably a water based solution, for several minutes. Substrates made from organic materials such as organic lens substrates are most often “colored” in the bulk of the material by dipping in aqueous baths, heated to temperatures of the order of 90° C., and in which the color-balancing means has been dispersed. This compound thus diffuses under the surface of the substrate and the color density is obtained by adjusting the quantity of compound diffusing in the body of the substrate,
II. the diffusion methods described in JP 2000-314088 and JP 2000-241601, involving an impregnable temporary coating,
III. contactless coloration using a sublimable material, such as described in U.S. Pat. No. 6,534,443 and U.S. Pat. No. 6,554,873, or
IV. incorporation of the compound during the manufacture of the substrate itself, for example by casting or injection molding, if it is sufficiently resistant to high temperatures present during casting or injection molding. This is preferably carried out by mixing the compound in the substrate composition (an optical material resin or a polymerizable composition) and then forming the substrate by curing the composition in an appropriate mold.

Several methods familiar to those practiced in the art of optical manufacturing are known for incorporating the optical filtering means (and/or the color-balancing means) in a layer. These compounds may be deposited at the same time as the layer, i.e., when the layer is prepared from a liquid coating composition, they can be incorporated (directly or for example as particles impregnated by the compound) or dissolved in said coating composition before it is applied (in situ mixing) and hardened at the surface of the substrate.

The color-balancing means and the optical filtering means (dye A and the optional one or more optical filtering means) can also be incorporated into a film that will be subsequently transferred, laminated, fused or glued to the substrate.

The optical filtering means (and/or the color-balancing means) may also be included in a coating in a separate process or sub-process. For example, the compound may be included in the coating after its deposition at the surface of the substrate, using a dipping coloration method similar to that referred to for “coloring” the substrate, i.e., by means of tinting bath at elevated temperatures, through the diffusion method disclosed in US 2003/0020869, in the name of the applicant, through the method disclosed in US 2008/127432, in the name of the applicant, which uses a printing primer that undergoes printing using an inkjet printer, through the method disclosed in US 2013/244045, in the name of the applicant, which involves printing with a sublimation dye by means of a thermal transfer printer, or though the method disclosed in US 2009/047424, in the name of the applicant, which uses a porous layer to transfer a coloring agent in the substrate. The compound may also be sprayed onto a surface before the coating is cured (e.g., thermally or UV cured), dried or applied.

Obviously, combinations of several of the above described methods can be used to obtain an optical article having at least one optical filtering means and/or color-balancing means incorporated therein.

The amount of optical filtering means (including dye A) used in the present invention is an amount sufficient to provide a satisfactory protection from blue light, while the amount of color-balancing means (including dye B) used in the present invention is an amount sufficient to offset the yellowing effect caused by the optical filtering means.

Naturally, the respective amounts of color-balancing means and optical filtering means may be adapted to each other to produce a transparent, colorless element, which does not have a yellow appearance, for example. In particular, those of skill in the art should appreciate that the desired amount of color-balancing means will vary depending on several factors including the nature and amount of the optical filtering means that is used. To this end, the optimal amounts of each compound can be determined by simple laboratory experiments.

For example the optical filtering dye can be used at a level of 0.005 to 0.150% based on the weight of the coating solution, depending on the strength of the dye and the amount of protection desired. In such cases, the color-balancing dye(s) can be used at a level of 0.01-0.10% on based on the weight of the coating solution, depending on the strength of the dyes and the final color and %Transmission desired. It should be understood that the invention is not limited to these ranges, and they are only given by way of example.

Obviously, the optical article according to the invention can only appear colorless if neither of its substrate and coatings is tinted.

In some embodiments, the optical article comprises at least one free radical scavenger, which is preferably incorporated in at least one of the first coating and the second coating. It is preferably included in the same layer as dye A and more preferably in the first coating. Most preferably, both the dye A and the free radical scavenger are incorporated in the first coating according to the invention. It is preferred not to use the radical scavenger in the second coating when it is an UV cured coating.

A stability improvement was obtained by adding a free radical scavenger in the coating comprising dye A, even if some coatings at the surface of the optical article are thermally and/or UV cured. Indeed, most of the dyes and in particular yellow dyes are sensitive to UV light, with certain levels of photo-degradation after irradiation with UV light.

Free radical scavengers inhibit the formation of or scavenge the presence of free radicals, and include hindered amine light stabilizers (HALS), which protect against photo-degradation, and antioxidants, which protect against thermal oxidation.

Preferably, the optical article comprises at least one hindered amine light stabilizer, and/or at least one antioxidant, more preferably at least one hindered amine light stabilizer and at least one antioxidant, which can be incorporated in the same or different layers, preferably both in the first coating. This combination of free radical scavengers offers the best protection from thermal and photo degradation to optical filtering means. Protection of optical filtering means from photo-degradation can also be reinforced by the presence on the optical article of an antireflection coating containing at least one mineral/dielectric layer.

In one embodiment, the free radical scavenger is a sterically hindered phenol or amine.

Preferred hindered amine light stabilizers are derivatives of piperidine, such as derivatives of 2,2,6,6-tetramethyl piperidine. They are commercially available from BASF under the trade names Tinuvin® and Chimassorb®.

Preferred antioxidants are sterically hindered phenols, thioethers or phosphites. They are commercially available from BASF under the trade names Irganox® and Irgafos®.

The amount of free radical scavenger that is used is an amount that is effective to stabilize the coating composition, which will depend on the specific compounds chosen and can be easily adapted by those skilled in the art.

In an embodiment, the optical article comprises a substrate having a front main face and a rear main face, wherein the mean reflection factor R_{UV} on said rear main face between 280 nm and 380 nm, weighted by the function W(λ) defined in the ISO 13666:1998 standard, is lower than 5%, for an angle of incidence on the rear face of 35°, or, in another embodiment, for both an angle of incidence of 30° and for an angle of incidence of 45°.

The optical article according to the invention may also comprise the following characteristics:

a mean blue light protection factor BVC between 400 nm and 450 nm, weighted by the function B(λ) represented on FIG. 1, defined through the following relation:

$$BVC = \frac{{\int }_{400}^{450} B ( λ ) \cdot T ( λ ) \cdot d λ}{{\int }_{400}^{450} B ( λ ) \cdot d λ}$$

ranges from 15 to 50%, preferably from 15 to 25%;

has a relative light transmission factor in the visible spectrum Tv higher than or equal to 80%, preferably higher than or equal to 89%, and having a ratio BVC/Yi higher than 2, preferably higher than 3, where Yi is the yellowness index of the optical article and BVC is the mean blue light protection factor between 400 nm and 450 nm, weighted by the function B(λ) represented on FIG. 1, defined through the following relation:

$$BVC = \frac{{\int }_{400}^{450} B ( λ ) \cdot T ( λ ) \cdot d λ}{{\int }_{400}^{450} B ( λ ) \cdot d λ} .$$

The optical articles according to the invention provide a better protection against retinal cell damage.

The substrate's main surface can be further coated with several functional coating(s) to improve its optical and/or mechanical properties. The term “coating” is understood to mean any layer, layer stack or film which may be in contact with the substrate and/or with another coating, for example a sol-gel coating or a coating made of an organic resin. A coating may be deposited or formed through various methods, including wet processing, gaseous processing, and film transfer. The functional coatings used herein are preferably an impact-resistant coating and an abrasion-resistant and/or scratch-resistant coating. Further functional coatings classically used in optics that may be present are, without limitation, an antireflection coating, a polarized coating, a photochromic coating, an antistatic coating, an anti-fouling coating, or a stack made of two or more such coatings.

The impact-resistant coating, preferably an impact-resistant primer coating, can be any coating typically used for improving impact resistance of a finished optical article. Also, this coating generally promotes adhesion of the further layers to the substrate in the end product, in particularly adhesion of the abrasion-resistant and/or scratch-resistant coating.

By definition, an impact-resistant coating is a coating that improves the impact resistance of the finished optical article as compared with the same optical article but without the impact-resistant coating.

Typical impact-resistant coatings are (meth)acrylic based coatings and polyurethane based coatings.

Preferred primer compositions include compositions based on thermoplastic polyurethanes, such as those described in the patents JP 63-141001 and JP 63-87223, poly(meth)acrylic primer compositions, such as those described in the patent U.S. Pat. No. 5,015,523, compositions based on thermosetting polyurethanes, such as those described in the patent EP 0404111 and compositions based on poly(meth)acrylic latexes or polyurethane latexes, such as those described in the patents U.S. Pat. No. 5,316,791 and EP 0680492.

Preferred primer compositions are compositions based on polyurethanes and compositions based on latexes, in particular polyurethane latexes, poly(meth)acrylic latexes and polyester latexes, as well as their combinations.

Poly(meth)acrylic latexes are latexes based on copolymers essentially made of a (meth)acrylate, such as for example ethyl (meth)acrylate, butyl (meth)acrylate, methoxyethyl (meth)acrylate or ethoxyethyl (meth)acrylate, with at least one other co-monomer in a typically lower amount, such as for example styrene.

Commercially available primer compositions suitable for use in the invention include the Witcobond® 232, Witcobond® 234, Witcobond® 240, Witcobond® 242 compositions (marketed by BAXENDEN CHEMICALS), Neorez R-962, Neorez R-972, Neorez R-986 and Neorez R-9603 (marketed by ZENECA RESINS).

The impact-resistant coating composition may be deposited onto the surface of the optical article, i.e., onto the first coating, or when present, the second coating according to the invention, using any classical method such as spin-coating, dip-coating, or flow coating, and then be dried or cured at a temperature of about 70-100° C. It is preferably in direct contact with the first coating, or when present, the second coating according to the invention.

The thickness of the impact-resistant coating in the final optical article typically ranges from 0.2 to 2.5 μm, preferably from 0.5 to 1.5 μm.

The abrasion-resistant and/or scratch-resistant coating (hard coating) can be any layer classically used as an abrasion-resistant and/or scratch-resistant coating in the field of optics.

Abrasion-resistant and/or scratch-resistant coatings are preferably based on poly(meth)acrylates or silanes, comprising typically one or more mineral fillers to increase the hardness and/or the refractive index of the coating once cured. As used herein, a (meth)acrylate is intended to mean an acrylate or a methacrylate.

Abrasion-resistant and/or scratch-resistant hard coatings are preferably prepared from compositions comprising at least one alkoxysilane and/or a hydrolyzate thereof, obtained for example through hydrolysis with a hydrochloric solution, and optionally condensation and/or curing catalysts and/or surfactants.

Recommended hard abrasion- and/or scratch-resistant coatings in the present invention include coatings obtained from silane hydrolyzate-based compositions (sol-gel process), in particular epoxysilane hydrolyzate-based compositions such as those described in the patents EP 0614957, U.S. Pat. No. 4,211,823 and U.S. Pat. No. 5,015,523.

Many examples of condensation and/or curing catalysts to be suitably used are indicated in “Chemistry and Technology of the Epoxy Resins”, B. Ellis (Ed.) Chapman Hall, New York, 1993 and “Epoxy Resins Chemistry and Technology” 2d edition, C. A. May (Ed.), Marcel Dekker, New York, 1988.

A preferred abrasion-resistant and/or scratch-resistant coating composition is the one disclosed in the patent EP 0614957, in the name of the applicant, which is used in the present examples.

The abrasion-resistant and/or scratch-resistant coating composition may be deposited onto the surface of the optical article, i.e., onto the impact-resistant coating, using any classical method such as spin-coating, dip-coating, or flow coating. It is thereafter cured in a suitable way (preferably using a heat- or an UV-treatment). It is preferably in direct contact with the impact-resistant coating.

The thickness of the abrasion-resistant and/or scratch-resistant coating does typically range from 2 to 10 μm, preferably from 3 to 5 μm.

Further details concerning impact-resistant (primer) coatings and abrasion-resistant and/or scratch-resistant coatings that may be used in the invention can be found in the application WO 2009/004222.

The abrasion-resistant and/or scratch-resistant coating is generally coated with an antireflective coating, and both coatings are preferably in direct contact.

The antireflection coating that may be used in the invention can be any antireflection coating traditionally used in the optics field, particularly ophthalmic optics. An antireflective coating is defined as a coating, deposited onto the surface of an optical article, which improves the antireflective properties of the final optical article. It makes it possible to reduce the light reflection at the article-air interface over a relatively large portion of the visible spectrum.

As is also well known, antireflection coatings traditionally comprise a monolayered or a multilayered stack composed of dielectric and/or sol-gel materials. These are preferably multilayered coatings, comprising at least one or two layers with a high refractive index (HI) and at least one or two layers with a low refractive index (LI), with a total number of layers typically ranging from 4 to 8. The antireflective coating outer layer is preferably a LI layer, more preferably a silica-based layer.

In the present application, a layer of the antireflective coating is said to be a layer with a high refractive index when its refractive index is higher than 1.55, preferably higher than or equal to 1.6, more preferably higher than or equal to 1.8. A layer of an antireflective coating is said to be a low refractive index layer when its refractive index is lower than or equal to 1.55, preferably lower than or equal to 1.50. Unless otherwise specified, the refractive indexes referred to in the present invention are expressed at 25° C. at a wavelength of 550 nm.

The HI and LI layers are traditional layers well known in the art, generally comprising one or more metal oxides, which may be chosen, without limitation, from the materials disclosed in WO 2011/080472, such as ZrO₂, TiO₂, SiO₂ and Al₂O₃.

Preferably, the antireflection coating total thickness is lower than 1 micron, more preferably lower than or equal to 800 nm and even more preferably lower than or equal to 500 nm. The antireflective total thickness is generally higher than 100 nm, preferably higher than 150 nm.

The various layers of the antireflective coating are preferably deposited according to any one of the methods disclosed in WO2008107325, such as spin-coating, dip-coating, spray-coating, evaporation, sputtering, chemical vapor deposition and lamination. A particularly recommended method is evaporation under vacuum.

The structure and preparation of antireflection coatings are described in more details in patent application WO 2010/109154.

The “mean light reflection factor,” noted Rv, is such as defined in the ISO 13666:1998 Standard, and measured in accordance with the ISO 8980-4 Standard (for an angle of incidence lower than 17[deg.], typically of 15[deg.]), i.e. this is the weighted spectral reflection average over the whole visible spectrum between 380 and 780 nm.

Antireflection coatings that can be used according to the invention have preferably Rv lower than 2.5% per face of the optical article, preferably lower than 1.5%, better lower than 1% and optimally lower than or equal to 0.6%.

In some aspects, the present invention provides an optical article further comprising a sub-layer, deposited before the antireflective coating, said sub-layer having preferable a refractive index lower than or equal to 1.55. The sub-layer is generally less than 0.5 micrometer thick and more than 100 nm thick, preferably more than 150 nm thick, more preferably the thickness of the sub-layer ranges from 150 nm to 450 nm. In another embodiment, the sub-layer comprises, more preferably consists in, silicon oxide, even better silica. Examples of usable sub-layers (mono or multilayered) are described in WO 2012/076174.

In some embodiments, the antireflective coating of the invention includes at least one electrically conductive layer. In a particular embodiment, the at least one electrically conductive layer has a refractive index greater than 1.55. The at least one electrically conductive layer serves as an antistatic agent. Without being bound by theory, the at least one electrically conductive layer prevents the multilayer antireflective coating stack from developing and retaining a static electric charge. The electrically conductive layer is preferably made from an electrically conductive and highly transparent material. In this case, the thickness thereof preferably varies from 1 to 15 nm, more preferably from 1 to 10 nm. Preferably, the electrically conductive layer comprises an optionally doped metal oxide, selected from indium, tin, zinc oxides and mixtures thereof. Tin-indium oxide (In₂O₃:Sn, tin-doped indium oxide), aluminum-doped zinc oxide (ZnO:Al), indium oxide (In₂O₃) and tin oxide (SnO₂) are preferred. In a most preferred embodiment, the electrically conductive and optically transparent layer is a tin-indium oxide layer or a tin oxide layer.

More details concerning the constitution and location of the antistatic layer can be found in the applications WO 2012/076714 and WO 2010/109154.

In a preferred embodiment, the optical article of the invention is configured to reduce reflection in the UVA- and UVB-radiation range, in addition to reducing reflection in the blue region, so as to allow the best health protection against UV and harmful blue light.

The UV radiation resulting from light sources located behind the wearer may reflect on the lens rear face and reach the wearer's eye if the lens is not provided with an antireflective coating which is efficient in the ultraviolet region, thus potentially affecting the wearer's health. In this regard, the optical article preferably comprises on its rear main face, and optionally on its front main face, an anti-UV, antireflective coating possessing very good antireflective performances in the visible region, and which is at the same time capable of significantly reducing the UV radiation reflection, especially ultraviolet A- and ultraviolet B-rays, as compared to a bare substrate or to a substrate comprising a traditional antireflective coating. Suitable anti-UV, antireflective coatings are disclosed in WO 2012/076714, the content of which is incorporated herein by reference.

The optical article according to the invention preferably has a relative light transmission factor in the visible spectrum Tv higher than or equal to 85 or 87%, preferably higher than or equal to 90%, more preferably higher than or equal to 92%, and better higher than or equal to 95%. Said Tv factor preferably ranges from 87% to 98.5%, more preferably from 88% to 97%, even better from 90% to 96%. The Tv factor, also called “luminous transmission” of the system, is such as defined in the standard NF EN 1836 and relates to an average in the 380-780 nm wavelength range that is weighted according to the sensitivity of the eye at each wavelength of the range and measured under D65 illumination conditions (daylight).

The optical article according to the invention has improved color properties, since it is color-balanced, which can be quantified by the yellowness index Yi. The degree of whiteness of the inventive optical article may be quantified by means of colorimetric measurements, based on the CIE tristimulus values X, Y, Z such as described in the standard ASTM E313 with illuminant C observer 2°. The optical article according to the invention preferably has a low yellowness index Yi, i.e., lower than 10, more preferably lower than 5, as measured according to the above standard. The yellowness index Yi is calculated per ASTM method E313 through the relation Yi=(127.69X−105.92Z))/Y, where X, Y, and Z are the CIE tristimulus values.

The optical article according to the invention may also comprise coatings formed on an antireflective coating and capable of modifying the surface properties thereof, such as hydrophobic and/or oleophobic coatings (antifouling top coats) or antifog coatings or precursors of antifog coatings. These coatings are preferably deposited onto the outer layer of the antireflective coating. As a rule, their thickness is lower than or equal to 10 nm, does preferably range from 1 to 10 nm, more preferably from 1 to 5 nm. Hydrophobic coatings are generally coatings of the fluorosilane or fluorosilazane type. They may be obtained by depositing a fluorosilane or fluorosilazane precursor, comprising preferably at least two hydrolysable groups per molecule. Fluorosilane precursors preferably comprise fluoropolyether moieties and more preferably perfluoropolyether moieties.

Optool DSX™, KY130™, OF210™, Aulon™ are examples of hydrophobic and/or oleophobic coatings. More detailed information on these coatings is disclosed in WO 2012076714.

The various coatings usable herein, such as the first coating, second coating, impact-resistant coating, and abrasion-resistant and/or scratch-resistant coating are preferably directly deposited on one another. These coating can be deposited one by one, or a stack of one or more coatings can be formed on the substrate, for example by lamination.

The following examples illustrate the present invention in a more detailed, but non-limiting manner. Unless stated otherwise, all thicknesses disclosed in the present application relate to physical thicknesses.

### EXAMPLES

The optical articles used in the examples comprise an ORMA® lens substrate from ESSILOR, having a 65 mm diameter, a refractive index of 1.50, a power of −2.00 diopters and a thickness of 1.2 mm.

The lens substrates were treated on the front face with a corona discharge, washed with soapy water, deionized water, dried with air, and coated on the front main face with a first coating according to the invention by spin coating. The coated lenses were thermally cured for 1 hour at 125° C., and subjected to the same corona treatment/washing procedure as above, and then coated with a second coating according to the invention by spin coating. The resulting lenses were cured by exposure to 5.5 J/cm² of energy in the UVA band, and post-cured for 3 hours at 105° C. in a convection oven. The first coating was 12 μm thick, and the second coating was 8 μm thick.

The coating composition for the first coating used in each of the examples is shown in table 1. Said composition comprises a solvent (N-methylpyrrolidone, NMP), an optical filtering means (ABS-420®, ABS-425® or ABS-430®, which are yellow dyes available from Exciton Inc., and SDA-4820®, which is a yellow dye commercially available from H. W. Sands Corp., Irganox 245® (antioxidant available from BASF), Tinuvin 144® (hindered amine light stabilizer available from BASF), Trixene B17960® (dimethyl pyrazole blocked hexane diisocyanate biuret available from Baxenden Chemicals Ltd.), Duranol T5652® (polycarbonate polyol available from Asahi Kasei Chemicals), a poly(meth)acrylic polyol available from PPG Industries), Silquest A-187® (3-glycidoxy-propyltrimethoxysilane, curing/cross-linking agent available from Momentive), BYK-333® (surfactant available from Byk-Gardner GmbH) and a metal catalyst designed for blocked isocyanate available from King Industries). The first coating composition of example 5 and comparative example 7 further comprises two color balancing means, D&C Violet #2 available from Tricon Colors Inc. and Morplas® Blue available from Keystone Aniline Corporation.

The coating composition for the second coating used in the examples comprises 4.9710 parts by weight of hydroxyethyl methacrylate (available from Aldrich), 10.3309 parts by weight of trimethylolpropane trimethacrylate, 54.8726 parts by weight of neopentylglycol diacrylate, 0.2506 parts by weight of Irgacure 819® (photo-initiator available from BASF), 0.2506 parts by weight of Lucirin TPO® (diphenyl [2,4,6-trimethylbenzoyl] phosphine oxide, photo-initiator available from BASF), 0.4976 parts by weight of a rheology modifier (polymeric resin available from PPG Industries), 20.0768 parts by weight of Desmodur PL-340® (blocked aliphatic polyisocyanate based on isophorone diisocyanate available from Bayer), 2.9232 parts by weight of ethanol (available from Acros Organics), and 5.8268 parts by weight of Sim 6500® (N-methylaminopropyl trimethoxysilane, curing/cross-linking agent available from Gelest, Inc.).

TABLE 1
First coating compositions.

| | Example | | | | | | |
|---|---|---|---|---|---|---|---|
| | 1 | 2 | 3 | 4 | 5 | 6 | 7 |
| NMP | 27.6066 | 27.6071 | 27.6081 | 27.6064 | 67.6105 | 27.6080 | 27.6198 |
| ABS-420 ® | 0.0098 | | | 0.0087 | 0.0087 | | |
| ABS-425 ® | | 0.0116 | | | | | |
| ABS-430 ® | | | 0.0161 | | | | |
| SDA-4820 ® | | | | | | 0.0156 | 0.0156 |
| Irganox 245 ® | 0.0033 | 0.0039 | 0.0054 | 0.0029 | 0.0086 | 0.0052 | 0.0215 |
| Tinuvin 144 ® | 0.0033 | 0.0039 | 0.0054 | 0.0029 | 0.0086 | 0.0052 | 0.0215 |
| D&C Violet #2 ® | | | | | 0.0066 | | 0.0462 |
| Morplas ® Blue | | | | | 0.0106 | | 0.0026 |
| Trixene BI7960 ® | 33.1172 | 33.1156 | 33.1117 | 33.1181 | 33.1032 | 33.1121 | 33.0698 |
| Duranol T5652 ® | 17.3689 | 17.3681 | 17.3661 | 17.3694 | 17.3616 | 17.3663 | 17.3441 |
| Poly(meth)acrylic polyol | 19.2266 | 19.2257 | 19.2234 | 19.2272 | 19.2185 | 19.2237 | 19.1991 |
| from PPG | | | | | | | |
| Silquest A-187 ® | 2.0956 | 2.0955 | 2.0952 | 2.0957 | 2.0946 | 2.0953 | 2.0922 |
| BYK-333 ® | 0.0397 | 0.0397 | 0.0397 | 0.0397 | 0.0397 | 0.0397 | 0.0396 |
| Metal catalyst | 0.5290 | 0.5290 | 0.5289 | 0.5290 | 0.5288 | 0.5289 | 0.5282 |
| Total (% parts by | 100 | 100 | 100 | 100 | 100 | 100 | 100 |
| weight) | | | | | | | |
| BVC (%) | 23.31 | 22.47 | 23.52 | 21.85 | 22.13 | 22.46 | 21.59 |
| Yi | 5.12 | 6.44 | 9.90 | 4.53 | 2.05 | 10.29 | 2.36 |
| Tv (%) | 91.35 | 91.39 | 90.90 | 91.22 | 89.26 | 91.41 | 84.71 |
| λ at maximum peak | 422 | 426 | 432 | 422 | 422 | 444 | 444 |
| absorbance (nm) | | | | | | | |
| FWHM (nm) | 14 | 17 | 23 | 13 | 13 | >50 | >48 |
| Ratio R1 (area) (A(435-460/A | 0.25 | 0.36 | 0.65 | 0.26 | 0.27 | 0.71 | 0.71 |
| (400-435) | | | | | | | |
| Ratio R2 (area 400-460 nm/area | | | | | 2.00 | | 2;39 |
| (460-700) | | | | | | | |
| Ratio R3 (area400-460/500-700) | | | | | 1.75 | | 2.06 |
| (BVC/Yi) | 4.55 | 3.49 | 2.38 | 4.82 | 10.8 | 2.18 | 9.15 |

Optical and Mechanical Performances

The light transmission factor in the visible spectrum Tv was measured in transmission mode from a wearer's view angle using a Cary 4000 spectrophotometer from Hunter, with the back (concave) side of the lens facing the detector and light incoming on the front side of the lens. The absorbance values were calculated as indicated above by converting transmittance values in absorbance values.

The yellowness index Yi was calculated as described above, by measuring on a white background with the above spectrophotometer the CIE tristimulus values X, Y, Z such as described in the standard ASTM E 313-05, through reflection measures, with the front (convex) side of the lens facing the detector and light incoming on said front side. This way of measuring Yi, from an observer's view angle, is the closest to the actual wearing situation.

Tv was measured under D65 illumination conditions (daylight).

The mean blue light protection factor BVC between 400 nm and 450 nm, weighted by the light hazard function B(λ), was calculated based on the transmission spectrum. It is defined through the following relation:

$$BVC = \frac{{\int }_{400}^{450} B ( λ ) \cdot T ( λ ) \cdot d λ}{{\int }_{400}^{450} B ( λ ) \cdot d λ}$$

wherein T(λ) represents the lens transmission factor at a given wavelength, measured at an incident angle between 0 to 17°, preferably at 0°, and B(λ) represents the light hazard function shown on FIG. 1 (relative spectral function efficiency). Said light hazard function results from work between Paris Vision Institute and Essilor International.

The calculation is made using the following coefficients

| Wavelength (nm) | Ponderation coefficient B (λ) |
|---|---|
| 400 | 0.1618 |
| 410 | 03263 |
| 420 | 0.8496 |
| 430 | 1.00 |
| 440 | 0.6469 |
| 450 | 0.4237 |

The calculation increment is 5 nm. Lens properties are summarized in table 1 above.

1.-17. (canceled)

18. An optical article comprising at least one absorbing dye A that selectively and at least partially blocks transmission of light having a wavelength ranging from 400 to 500 nm, wherein dye A has an absorption peak in the range from 400 nm to 460 nm and the absorption spectrum of the optical article is such that the contribution to absorption in the range 400-435 nm is higher than in the range 435-460 nm.

19. The optical article of claim 18, wherein the absorption spectrum of the optical article is such that the ratio R1 of the area under the curve from 435 to 460 nm and the area under the curve from 400 to 435 nm is lower than 0.7.

20. The optical article of claim 18, wherein the absorption spectrum of the optical article is such that the ratio R1 of the area under the curve between 435 and 460 nm and the area under the curve between 400 and 435 nm is lower than 0.6.

21. The optical article of claim 18, wherein dye A has an absorption peak in the range from 400 nm to 428 nm.

22. The optical article of claim 18, wherein dye A has an absorption peak in the range from 415 nm to 428 nm.

23. The optical article of claim 18, wherein dye A has an absorption peak in the range from 400 nm to 460 nm that exhibits a full width at half maximum lower than or equal to 40 nm.

24. The optical article of claim 18, comprising at least one color balancing dye B having an absorption peak at a wavelength higher than or equal to 500 nm.

25. The optical article of claim 24, wherein the color balancing dye B is an anthraquinone.

26. The optical article of claim 18, wherein dye A has a specific absorption coefficient higher than 200 L.g⁻¹.cm⁻¹ in methylene chloride.

27. The optical article of claim 18, wherein dye A has an absorption peak at a wavelength higher than or equal to 500 nm.

28. The optical article of claim 18, further comprising at least one optical filtering means different from dye A that at least partially blocks transmission of light having a wavelength ranging from 400 to 500 nm.

29. The optical article of claim 28, wherein said optical filtering means is an interferential filter.

30. The optical article of claim 28, wherein said optical filtering means is an antireflection coating.

31. The optical article of claim 18, comprising a substrate with a front main face and a rear main face, wherein the mean reflection factor R_{UV} on said rear main face between 280 nm and 380 nm, weighted by the function W(λ) defined in the ISO 13666:1998 standard, is lower than 5%, for both an angle of incidence of 30° and for an angle of incidence of 45°.

32. The optical article of claim 18, having an absorption spectrum such that the ratio R2 of the area under the curve from 460 to 700 nm and the area under the curve from 400 to 460 nm is lower than or equal to 3.

33. The optical article of claim 18, wherein the mean blue light protection factor BVC between 400 nm and 450 nm, weighted by the function B(λ) represented on FIG. 1, defined through the following relation:
$$BVC = \frac{{\int }_{400}^{450} B ( λ ) \cdot T ( λ ) \cdot d λ}{{\int }_{400}^{450} B ( λ ) \cdot d λ}$$
ranges from 15 to 50%.

34. The optical article of claim 18, further comprising at least one photochromic dye C and/or free radical scavenger.

35. The optical article of claim 18, having a relative light transmission factor in the visible spectrum Tv higher than or equal to 80%, and having a ratio BVC/Yi higher than 2, where Yi is the yellowness index of the optical article and BVC is the mean blue light protection factor between 400 nm and 450 nm, weighted by the function B(λ) represented on FIG. 1, defined through the following relation:
$$BVC = \frac{{\int }_{400}^{450} B ( λ ) \cdot T ( λ ) \cdot d λ}{{\int }_{400}^{450} B ( λ ) \cdot d λ} .$$

36. The optical article of claim 35, wherein the relative light transmission factor in the visible spectrum Tv is higher than or equal to 89%.

37. The optical article of claim 18, further defined as an ophthalmic lens.
